(19) United States
(12) Patent Application Publication
(10) Pub. No.: US 2016/0059529 A1
(43) Pub. Date: Mar. 3, 2016

(54) DEVICE FOR EVALUATING A PRODUCT ON APPLICATION

(71) Applicant: L'OREAL, Paris (FR)

(72) Inventors: Franck GIRON, Ferrieres en Brie (FR); Florian GHIGLIONE, Gometz le Chatel (FR); Frédéric FLAMENT, Paris (FR)

(21) Appl. No.: 14/784,715

(22) PCT Filed: Apr. 11, 2014
(86) PCT No.: PCT/IB2014/060644

§ 371 Date: Oct. 15, 2015

(30) Foreign Application Priority Data
Apr. 15, 2013 (FR) 13 53372

(51) Int. Cl. B32B 27/40; B32B 25/08; G01J 3/46; B29C 39/12; B29C 39/10; B29C 37/00; B32B 7/02; B32B 25/20

(52) U.S. Cl. CPC B32B 27/40; B32B 7/02; B32B 25/08; B32B 25/20; B29C 39/12; B29C 39/10; B29C 37/0032; G01J 3/46; B32B 2250/24; B32B 2274/00; B32B 2307/536; B32B 2307/538; B32B 2555/00; B29C 2037/0046; B29K 2083/00

(57) ABSTRACT

A device or evaluating a product on application, including an application surface defined by a multilayer complex which has at least two application regions which differ in terms of their surface condition and/or their hardness, the multilayer complex including a skin layer and an underlying support layer made of elastomer, the device being arranged to allow the application of the product to the regions in a single action.

The present invention relates to the evaluation of properties of cosmetic or dermatological products, after application, and also to devices for evaluating skin typology, also called atlas, and to the production of epitheses.

The behaviour on application and/or the effect obtained after application of a cosmetic product varies a great deal from one individual to the other. It depends, inter alia, on the skin relief, on the firmness of the tissues or else on the physicochemical properties of the skin.

The development of cosmetic products involves examining various parameters during application, according to the desired benefit of the product, such as colour or wear.

Certain parameters can be determined on in vitro supports, which may or may not reproduce the biology of the skin.

At the current time, the supports used to test cosmetic products most commonly consist of silicone or rubber prostheses, polyurethane (PU) supports which mimic the skin, biological supports such as reconstructed skin, intestines, and rough PMMA supports.

A synthetic skin model which is widely used is the product known under the trade name Bioskin, sold by the company Beaulax. It is composed of a multilayer structure comprising two layers of PU elastomer. The Bioskin application supports are provided with various skin colours or with various surface conditions. In order to test a product on application, the operator must successively apply the product to the various supports, and in order to enable a comparison under equivalent application conditions, must reproduce as faithfully as possible the application conditions from one support to another, which can prove to be difficult without equipment. However, the use of equipment for automatically and reproducibly spreading a product is relatively lengthy to implement, expensive, and not necessarily representative of the actual use of a product.

One of the Bioskin application supports is provided with coloured marks which are darker than the rest of the application surface, of various colours. Another of the known Bioskin supports groups together, on the same sheet, application supports with different grades of crows feet wrinkles, with a gap between said supports.

The various known supports do not, however, have the properties required to be able to be completely satisfactorily predictive of an in vivo application.

US 2007/0288186 A1 discloses a method for evaluating a product comprising the application of said product to an artificial support and a step of analysing the support thus coated. This support may comprise polyurethane and may be textured and may mimic the skin relief.

WO 2007/021844 discloses an article comprising a substrate coated with a layer of coating and which can have a relief that mimics that of the skin.

JP H11 169390 discloses an artificial skin comprising a skin layer and an underlying part for simulating flesh, wherein both the skin layer and the underlying part are made by polyurethane. A silicone mould is used to produce the microrelief on the skin layer.

JP 2012 061213 discloses a device for verifying the colour of a cosmetic composition. The device comprises zones of different colours that simulate colours and surface condition of the different parts of the skin.

The invention aims, inter alia, to provide a novel tool which facilitates the evaluation of cosmetic or dermatological products, in particular on application, and which remedies all or some of the drawbacks of the known application supports.

According to one aspect of the invention, a subject thereof is a device for evaluating a product on application, comprising an application surface defined by a multilayer complex which has at least two application regions which differ in terms of their colour, their surface condition and/or their hardness, the multilayer complex comprising a skin layer and an underlying support layer made of elastomer, the device being arranged to allow the application, in particular manual application, of the product to said regions in a single action.

According to another aspect of the invention, a subject thereof is a device for evaluating a skin typology or a product on application, which has an external surface defined by a multilayer complex which has at least two application regions which differ in terms of their colour, their surface condition and/or their hardness, the multilayer complex comprising a skin layer and an underlying support layer made of elastomer, the skin layer reproducing the skin relief.

According to yet another aspect of the invention, a subject thereof is a device for evaluating a skin typology or a product on application, which has an external surface defined by a multilayer complex which preferably has at least two regions which differ in terms of their colour, their surface condition and/or their hardness; the multilayer complex comprises a skin layer made of polyurethane elastomer and an underlying support layer made of silicone elastomer.

According to yet another aspect of the invention, a subject thereof is a device for evaluating a product on application, comprising an application surface defined by a multilayer complex which has a skin layer, in particular made of elastomer, and a support layer made of elastomer, and, between the two, at least one intermediate element which makes it possible to carry out a detection or a physicochemical measurement or which promotes the adhesion between the skin layer and the support layer. This intermediate element is, for example, a functional layer comprising a compound capable of interacting with one or more predefined target molecules, having migrated through the skin layer, such as UV photochromes which will redden the appearance of the application surface according to the amount of UV radiation received. This element may also be a layer of colouring agent provided by a printer. Finally, this may be a sprayed adhesive.

The device may have at least two regions which differ in terms of their colour, their surface condition and/or their hardness, and/or at least two regions which have different respective functional layers. These regions may be the same, that is to say the regions differ, on the one hand, in terms of their colour, their surface condition and/or their hardness, and, on the other hand, in terms of the corresponding functional layer.

The expression “to allow the manual application of a product in a single action” should be understood to mean that the operator can apply the product to one of said regions and can then continue the application towards the other region while maintaining the contact between the application means used and the multilayer complex. For example, the user moves his finger loaded with product over the two regions in a single action, without having to lift the finger in order to go from one region to the other. The operator can also move a stick product over said regions while maintaining continuous contact between the product and the multilayer complex.

Preferably, the application regions are juxtaposed and contiguous, that is to say that as soon as the user leaves one of the regions, he starts on the adjacent region; the arrangement of the test regions is thus different from the abovementioned Bioskin application support, where the various application regions reproducing different wrinkle grades are spaced out from one another on a sheet of support, such that it is not possible to continue an application action begun on one of the application supports, on the adjacent support, without coming up against the projection created by the gap left between the application supports.

In one preferred implementation of the invention, it is thus advantageously possible to go from one region to the adjacent region without encountering any detachment.

By virtue of the invention, the user has a tool which makes it possible to very rapidly evaluate the behaviour on application of a product with respect to various skin characteristics, such as the condition of the skin or the hardness of the flesh.

During the testing of a product, the operator can move the applicator over the application surface of the device along a continuous path extending at least partially on each of said regions. Because the operator can reach regions with different properties, in a single application action, if so desired, the application conditions on each of the regions are similar and the comparison of the results on application is not only facilitated, but also more precise.

The number of regions having different properties is preferably more than two, and can advantageously range from 3 to 10, or even several tens of regions.

A device according to the invention is of use for evaluating a characteristic of a product on application. It can also be used as an atlas, allowing not only a visual comparison between a region to be evaluated and the various regions of the atlas, but also a tactile comparison, in particular when the hardness varies from one region to another on the device by virtue of the modification of the mechanical properties of the support layer made of elastomer located under the skin layer.

The invention can also be applied to the production of a contrast card. A known contrast card consists of a cardboard sheet which has two regions that are respectively white and black. The covering capacity of a product can be evaluated by measuring the difference ΔL (L*_{background1}−L*_{background2}), where L*_{background1} denotes the value of L* on a white background and L*_{background2} denotes the value on a black background, or by measuring the opacity or the Contrast Ratio (CR %) (Y_{black background}/Y_{while background}×100) of a layer of product spread both on the white region and on the black region.

A device according to the invention can have two regions which are respectively coloured white and black in order to carry out colourimetric measurements on a layer of product covering these regions. Unlike a smooth contrast card which may require the use of a spreader, the invention makes it possible to immediately assess the covering capacity under application conditions similar to the actual conditions. The regions coloured white and black can be added to other skin-coloured regions, as appropriate.

A subject of the invention is thus also a contrast card comprising a multilayer complex defining two application regions of different colours, in particular respectively white and black, the multilayer complex comprising a skin layer, in particular made of elastomer, and a support layer made of elastomer, the skin layer preferably being microstructured, preferably reproducing the skin relief, the skin layer preferably being made of polyurethane elastomer, and the support layer preferably being made of silicone elastomer, in particular from a reactive silicone.

Generally, the two regions can differ by virtue of their surface condition, which preferably reflects various grades of skin typology, such as skin of increasing age, skin exhibiting an increasing pore size, skin exhibiting an increasing number of skin defects and/or skin exhibiting wrinkles which are increasingly marked and/or increasingly numerous.

The two regions can differ by virtue of their colour, in order in particular to reproduce various skin colours encountered among the same skin type, for example caucasian or asian, or among various skin types.

The two regions can differ by virtue of their hardness, in order, for example, to be representative of two areas of the body covering more or less firm flesh.

It is particularly advantageous for the two regions to reproduce a skin microrelief, the skin layer preferably being moulded with said microrelief. This may be the relief of the skin of a part of the face, of the arm or of the back, for example.

The colour and relief characteristics of a region can be reproduced from the same individual from whom a skin impression is taken and whose skin colour is measured in the area where the impression is taken. As a variant, there is no correlation between the two characteristics.

The two regions can be pinpointed by identifiers, which can be printed or formed by alphanumeric patterns having come from moulding with the skin layer for example.

The two regions may vary only in terms of hardness, colour or surface condition. Regions exhibiting different surface conditions may be of the same colour. Regions exhibiting different hardnesses may be of the same colour.

Preferably, the skin layer and the support layer are made of different material.

The skin layer is advantageously made of elastomer, preferably of PU elastomer. The support layer is advantageously made of silicone elastomer.

On the external surface, one of the surface-condition, colour or hardness characteristics may vary in a first direction, while another of said characteristics varies in another direction, which may be perpendicular to the first.

The device may comprise at least three regions, one characteristic of which, chosen from the surface condition, the colour or the hardness, exhibits different grades.

The various regions may be arranged around a central zone of a disc, which central zone can advantageously receive said white or black regions, for example each in the form of a half-disc.

As a variant, the various regions are in the form of juxtaposed parallel strips, preferably of the same width.

A subject of the invention is also an atlas for evaluating the firmness of the skin, comprising various regions reproducing the appearance of a mark made on the skin by applying an end piece to said skin with a predefined force. The various regions are produced with a multilayer complex comprising a skin layer and a support layer. The skin layer is preferably made of elastomer, in particular polyurethane elastomer. The support layer is preferably made of elastomer, in particular silicone elastomer. The various marks reproduced correspond to as many grades of firmness of the skin.

Each application region can occupy an area of between 1 and 150 cm² for example. The total extent of the application surface may be between 2 and 400 cm².

A subject of the invention is also a method for evaluating on application a cosmetic or dermatological product, comprising the following steps:
applying the product to an evaluating device according to the invention, so as to at least partially cover two of said regions with the product, the application of the product preferably being carried out in a single action. The regions may, as detailed above, exhibit different surface conditions and/or different hardnesses.

During the application of the product, the device can sit in a fixed manner on a workbench or table for example. The application surface can then be planar. The total thickness of the multilayer complex is preferably less than or equal to 2.5 mm and better still to 0.5 mm.

According to another aspect of the invention, the total thickness of the complex is between 2 mm and 20 mm, preferentially between 5 mm and 10 mm. According to another aspect of the invention, the multilayer complex has a total thickness of between 20 mm and 100 mm.

A subject of the invention is also a method for evaluating the firmness of the skin, in which an atlas for evaluating firmness as defined above is used, this method comprising the steps consisting in:
applying an end piece to the skin with a predefined force, for a controlled duration,
removing the end piece,
comparing the appearance of the mark left on the skin with the appearance of the various regions of the device and selecting the one with the most similar appearance.

A subject of the invention is also a method for evaluating the firmness of the skin, in which an atlas for evaluating firmness as defined above is used, this method comprising the steps consisting in palpating the skin and a plurality of regions of the evaluation atlas, and in comparing the hardness and/or the surface condition of the skin to the touch, with the regions of the atlas.

Yet another object of the invention is to provide a method for manufacturing a multilayer complex for any one of the evaluating devices as defined above, the application surface of which is produced with a colour and/or patterns which are visible, reproducing for example skin colour heterogeneities and/or identifiers.

According to this method, a composition intended to form the skin layer is applied in a mould, printing on an internal face of this skin layer is carried out, for example with a printer, and then a composition intended to form the support layer is poured into the mould, on the skin layer thus printed. The printing on the skin layer is visible on the application surface by virtue of the transparency of the non-opaque skin layer, the thickness of which is preferably relatively small, preferably less than 5 μm. Where appropriate, a flat colour tint can be printed on the skin layer, which can avoid having to mass-colour the support layer. When a pattern is printed on the internal face of the skin layer as above, this pattern is repeatable from one epithesis to another, and therefore perfectly reproducible. It is also possible to both mass-colour the support layer and print the skin layer, so as, for example, to darken or shade its tint. It is possible to obtain regions of different colours by printing the skin layer with different colours. The printing can be carried out using the trichrome or quadrichrome technique with an inkjet printer or transfer printer. It is possible to print patterns which vary in order to reproduce the appearance of marks, blood vessels, spots, blackheads, scars, beauty spots, etc.

A subject of the invention is also a method for manufacturing a multilayer complex comprising a skin layer which preferably reproduces the skin microrelief and a support layer made of elastomer, intended to simulate the viscoelastic behaviour of the skin, in which method a composition intended to form the skin layer is applied in a mould, then a layer of a compound intended to react with one or more predefined target molecules is applied to the internal face of the skin layer, and then a composition intended to form the support layer is applied.

A subject of the invention, according to another of its aspects, is also an epithesis or a device, for evaluating a cosmetic or dermatological product on application, comprising:
a skin layer, preferably made of elastomer, in particular of polyurethane elastomer, which is preferably microstructured, which more preferably reproduces the skin microrelief, the skin layer defining, with its external surface, the optional application surface and being printed on its internal face,
a support layer, preferably made of elastomer, better still of silicone elastomer, covered by the skin layer.

The support layer in this case can have two types of forms on the internal side: a planar form, or a form complimentary to the area on which this epithesis will be placed, in particular for wrinkle-filling applications.

The multilayer complex may have thin edges on a band of a few mm, for example from 1 to 10 mm, preferentially 2 to 4 mm, on which band there is only the skin layer, making it possible to form a connection with the neighbouring skin.

The invention may be better understood on reading the following description of non-limiting implementation examples thereof, and with reference to the attached drawing, in which:

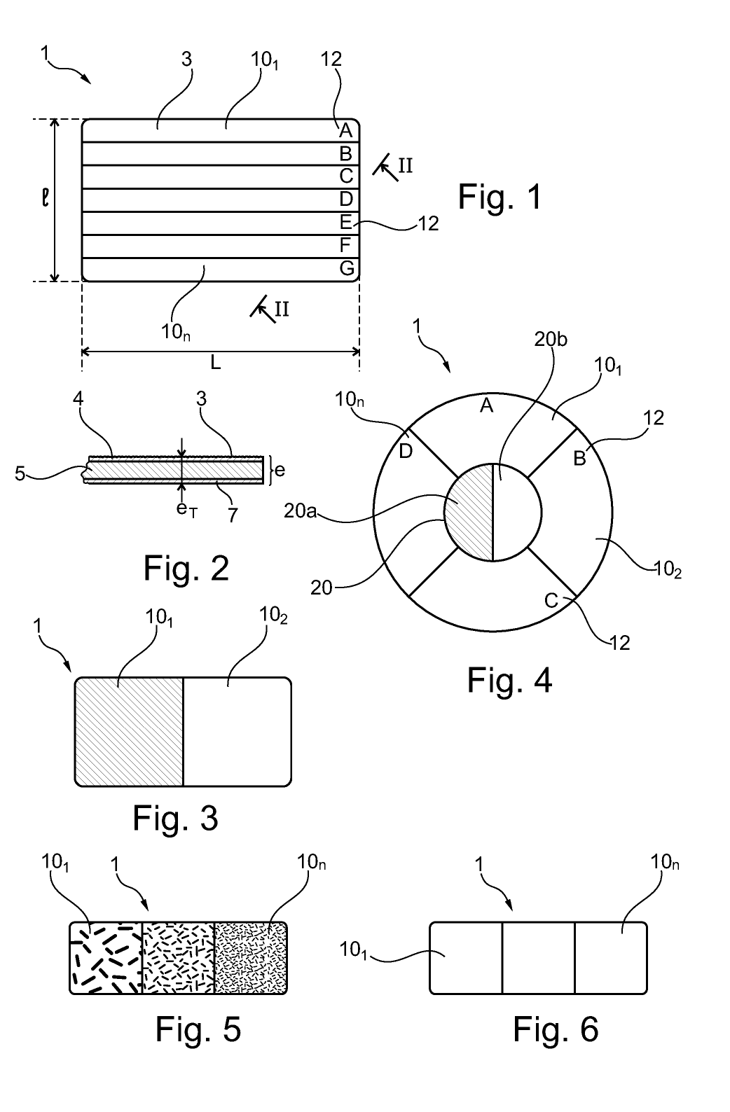

FIG. 1 represents an example of an evaluating device according to the invention,

FIG. 2 is a partial and schematic section along II-II of FIG. 1,

FIGS. 3 to 10 are views similar to FIG. 1 of embodiment variants,

FIG. 11 is a view similar to FIG. 2 of an embodiment variant,

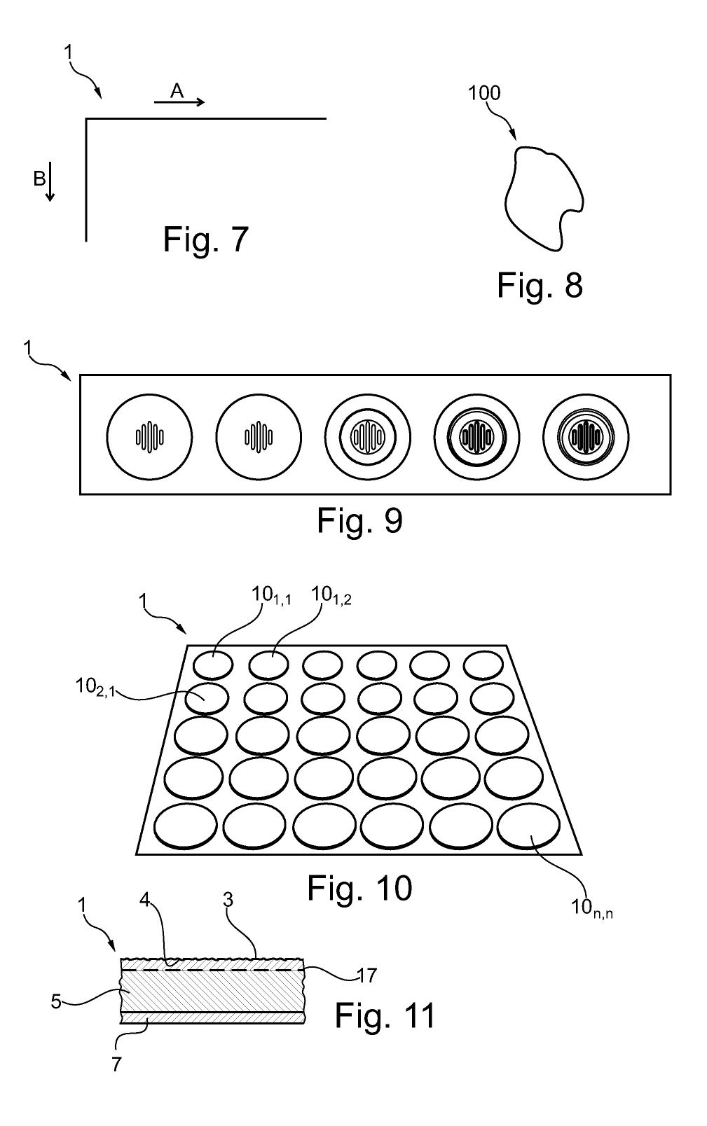

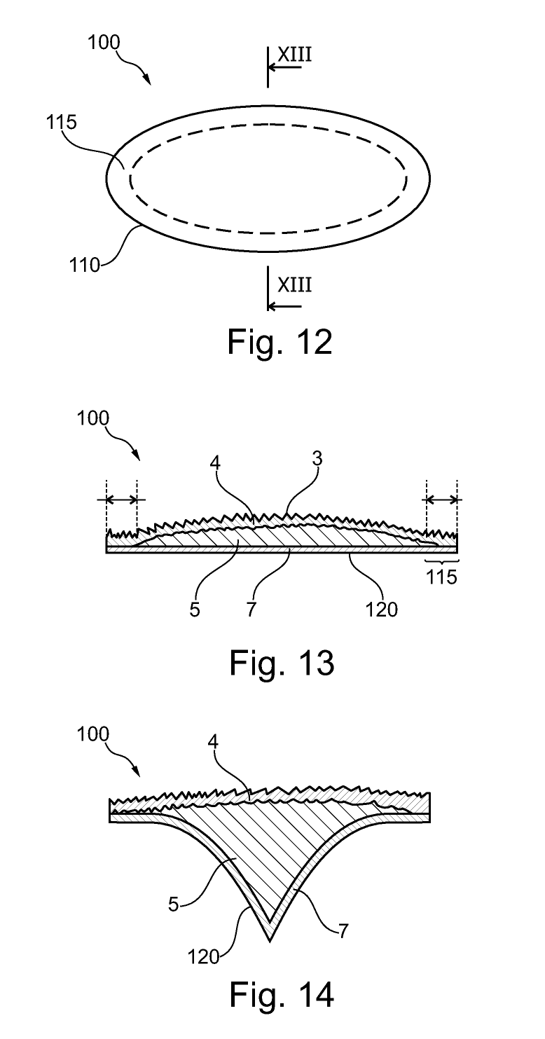

FIG. 12 is a view similar to FIG. 8 of an epithesis embodiment variant,

FIG. 13 is a schematic sectional view along XIII-XIII of FIG. 12, and

FIG. 14 is a view similar to FIG. 13 of an embodiment variant.

In the figures, and in particular FIG. 2, the actual proportions have not been adhered to in the interests of clarity.

The evaluating device 1 according to the invention, represented in FIG. 1, comprises a multilayer complex 2, the structure of which appears in FIG. 2, defining an application surface 3 to which the product that it is sought to be evaluated can be applied.

The multilayer structure 2 comprises a skin layer 4 and a support layer 5 in contact with the skin layer 4.

The multilayer structure 2 can advantageously comprise, as illustrated, a second skin layer 7, facing the first.

The device 1 is, for example, in the form of a plate, the outline of which can be substantially rectangular with rounded corners, as illustrated in FIG. 1, or circular, as illustrated in FIG. 4.

The device 1 has at least two test regions 10₁ to 10ₙ which have different characteristics with respect to the application of the product, it being possible for n to be an integer between 2 and 30.

The various test regions can be pinpointed on the application surface side, where appropriate, by identifiers 12 such as alphanumeric characters.

In the example illustrated, the regions 10₁ to 10ₙ are in the form of juxtaposed strips extending, for example, over the entire length of the device 1.

At least one characteristic chosen from the colour, the surface condition and the hardness varies from one region to the other.

Thus, in one example, the various regions 10₁ to 10ₙ correspond to as many different grades of skin colour, of skin relief or of hardness.

There is, for example, the colour of the regions 10₁ to 10ₙ which becomes darker from one region to the other, between extreme regions 10₁ and 10ₙ which are respectively the lightest and the darkest.

The device comprises, for example, five application regions, the respective colours of which are the following (each value L*, a* or b* being expressed to within 15%):

| L* | a* | b* |
|---|---|---|
| 70 | 9.6 | 23.7 |
| 62 | 14.8 | 21 |
| 59 | 12.9 | 25.7 |
| 59 | 10.6 | 29 |
| 51 | 20.7 | 30.9 |

There can also be the surface condition which goes, between two extreme regions, from very smooth skin, the pores of which are rather closed, representative of young skin for example, to skin full of skin defects or with pores which show, for example representative of aged skin, with several intermediate grades in between.

The device comprises, for example, five test regions, the microrelief of which varies according to the average pore volume of the area (each value is expressed to within 20%, in mm³):

| | | | | |
|---|---|---|---|---|
| 0.0008 | 0.0013 | 0.0019 | 0.0026 | 0.0036 |

It is also possible to go from a softer region to a harder region, via various grades of hardness.

The device comprises, for example, six regions, the hardness of which is the following, expressed as Shore hardness (to within 25%):

| | | | | | |
|---|---|---|---|---|---|
| OO-35 | OO-25 | OO-20 | OO-15 | OO-10 | OO-5 |

Multilayer Complex

Skin Layer

Preferably, the skin layer 4 is made of elastomer, and more preferably polyurethane (PU).

The polyurethane used is for example the product sold under the reference Baldiez or Super Baldiez by the company Mouldlife.

Its thickness is preferably less than or equal to 15 μm, better still less than or equal to 10 μm or 5 μm, being preferably between 0.5 and 2 μm.

Preferably, the skin layer 4 reproduces the skin microrelief, having been obtained from an impression taken from the skin.

It is possible for the skin layer 4 not to contain pigment or colouring agent; the perceived colour of the external surface can result from a colouration of the support layer 5 and the transparency of the skin layer.

The relief of the skin layer 4 may be obtained by moulding the latter in contact with a mould wall exhibiting the negative of the relief to be reproduced. The mould relief may result from taking an impression or from micro-machining or from manufacturing with the aid of a three-dimensional printer, after acquisition, using optical means, of the relief to be reproduced.

The relief of the skin layer may have a roughness similar to that of the skin, for example with the roughness parameter Ra between 15 and 75 μm, and the parameter Rz between 50 and 170 μm

The microrelief expressed as a function of the average pore volume of the area ranges, for example, from 100% to 500% between test regions with the extreme properties, ranging, for example, from 0.0005 mm³ to 0.0040 mm³.

Reference may advantageously be made to the publication “Atlas du vieillissement cutané” (“Atlas of skin ageing”), published in the Med'Com Editions, for choosing the form and the appropriate microrelief.

Support Layer

The support layer 5 is preferably made of elastomer, and more preferably of crosslinked silicone elastomer. It can be obtained from a reactive silicone. The reactive silicone used may for example be the product sold under the reference “Plat-Sil gel 10′” by the company Mouldlife.

Oil may be added to the formulation of the support layer prior to crosslinking, thereby making it possible to modulate the hardness of the elastomer, depending on the quantity of oil introduced. The oil added is preferably a silicone oil. This also makes it possible to render the elastomer slightly adhesive, thus ensuring adhesion with the skin layer.

The support layer can thus be produced from a mixture of “Plat-Sil gel 10′” reactive silicone and Smiths Prosthetic Deadener silicone oil from the company Mouldlife.

The support layer 5 may be produced with a reactive silicone which, if silicone oil is not added, results in an elastomer having a Shore A hardness of between 5 and 15, better still 8 and 12, in particular approximately 10.

The reactive silicone may comprise a platinum salt as catalyst.

The colour of the multilayer complex may be adjusted by mass-tinting the support layer, in particular by tinting the elastomer of the support layer or the oil introduced into the latter. Pigments or colouring agents may thus be introduced into the support layer. Preferably, the application surface has a skin colour, except in the application with the contrast card alone. The colour of the multilayer complex may also be obtained by printing the internal face of the skin layer, in particular using a printer.

Second Skin Layer

The multilayer complex may comprise another skin layer 7 under the support layer 5, which may have the same formulation as the first skin layer 4, and may or may not have a microstructured surface condition. This second skin layer 7 may be smooth.

The total thickness of the multilayer complex is then, as required, preferably less than or equal to 2.5 mm and better still less than or equal to 0.5 mm.

In one embodiment, the total thickness of the complex is between 2 mm and 20 mm, preferentially between 5 mm and 10 mm. In another embodiment, the multilayer complex has a total thickness of between 20 mm and 100 mm.

Method for Manufacturing the Multilayer Complex

In order to manufacture the multilayer complex, a mould may be produced in the following way:
a negative impression is taken of an area of the body of which the skin microrelief is to be reproduced in at least one region, for example the back, using an impression-taking product such as the one known under the reference Silflo,
a positive is produced from this impression taken, for example using a resin, such as the Chavant Clay plastiline distributed by the company MouldLife,
the mould is produced from the positive using, for example, Elastocil M4600 silicone of the Wacker brand. Reference may be made to the indications given by the company Wacker regarding the production of a mould, known in itself.

Next, in order to produce the multilayer complex according to the invention from this mould, the following steps can be carried out:
airbrush deposition of the elastomer intended to form the skin layer, said elastomer being for example diluted in acetone, the total thickness of the skin layer deposited being for example 3 μm; a plurality of successive thin layers, for example three layers, can be airbrush deposited,
mixing of the compounds intended to form the support layer, in particular silicone elastomer and oil, and optional pigments or colouring agents,
pouring or injection of the mixture into the mould, or into a part of the latter,
airbrush deposition of the elastomer intended to form the optional second skin layer, for example in the form of successive thin layers, as for the first skin layer,
removal from the mould.

As a variant, the relief of the mould is produced by digital acquisition of the relief followed by reproduction using a three-dimensional printer.

No matter how the mould is provided with the microrelief which will be used to produce that of the application surface, the mould may define a cavity, the shape of which may vary depending on the purpose of the multilayer complex. The mould may define a cavity having the general shape of a revolving cylinder or prism, inter alia.

Before pouring the support layer, it is possible to deposit on the first skin layer, by printing or otherwise, a layer which is intended to provide colour or a function consisting of detection or measurement of a target molecule having migrated through the first skin layer.

Colour Variation

The colour of a region can be obtained by locally colouring the support layer of the multilayer complex using pigments for example, the first skin layer 4 allowing the colour of the support layer 5 to appear by transparency. Among the pigments that can be used, mention may be made of iron oxides.

In order to obtain several colours, mixtures formulated differently in terms of colouring agents used can be successively introduced into the mould during the manufacturing of the multilayer complex. One or more removable partitions can be introduced in order to limit the filling of the mould to a sub-part thereof during the introduction of each mixture. The partition(s) can be removed during crosslinking; the constituents of the adjacent areas thus do not mix together, while at the same time being adjoining.

In the case of the exemplary embodiment of FIG. 1, it is thus possible to successively mould the part of the support layer corresponding respectively to the various regions with mixtures of different colours.

The appearance of skin colour heterogeneities can be reproduced by printing the skin layer on its internal face in the mould, before pouring the silicone elastomer onto said layer in the mould. The printing can, for example, simulate marks such as age spots.

An alphanumeric identifier can also be printed on the internal face of the skin layer.

The printing of the internal face of the skin layer can be carried out using an inkjet printer or transfer printer, for example the Gatocopy LiftA4 printer of the Cerfdellier brand.

The printing of the internal face of the skin layer can also be of use for producing regions of different colours. In this case, the skin layer is printed with flat tints of different colours, for example corresponding respectively to increasingly dark skin. Next, the support layer is cast, it being possible for the latter to be mass-tinted with the lightest skin colour. This makes it possible to take advantage of the fact that the layer of ink deposited by printing is not completely opaque. It is nevertheless of use for locally darkening the appearance of the application surface.

Another advantage linked to the printing of the skin layer is that of making the distribution of the colours independent of the distribution of the various compositions intended to mould the support layer, when several compositions are used to mould the support layer, for example in order to produce test regions having a variable hardness.

The fact that the internal face of the skin layer is printed also makes it possible to avoid contact of the inks with the products applied on the application surface, which could lead to solubilisation of these inks by the solvents used and could affect the appearance of the product deposit produced.

Represented in FIG. 11 is an example of a multilayer complex in which a printing layer or functional layer 17 is present between the support layer 5 and the first skin layer 4.

Surface Condition Variation

In order to obtain a surface condition variation, the mould is produced in the corresponding way.

Each region of the mould intended to mould one of the regions 10₁ to 10ₙ is produced from an impression.

For example, an impression is taken of the skin relief on the same region of the body or of the face of various individuals chosen to reflect a change in the surface condition of the skin, for example individuals of different ages.

It is also possible to choose to take impressions in order to reflect various grades of a skin defect, such as various degrees of the appearance of wrinkles.

The surface condition features for which it may be sought to reproduce various grades are, for example, the following:
pore size,
number and depth of wrinkles,
presence of traces of acne,
desquamation,
presence of spots or skin outgrowths,
presence of orange peel skin,
and also everything which is described in the publication “Atlas du vieillissement cutané” (“Atlas of skin ageing”), published in the Med'Com Editions.

Hardness Variation

Hardness variation can reflect the presence of more or less firm flesh or the covering of various elements, such as fat, muscle or bone, by the skin.

In order to obtain a hardness variation, it is possible to act on the formulation of the support layer and in particular to introduce a smaller or greater proportion of oil prior to crosslinking. It is possible, for example, to vary, within a mixture of Plat-Sil gel 10′ reactive silicone and Smith Prosthetic Deadener silicone oil, the proportion by weight of oil between 20% and 70% relative to the total weight of the mixture.

It is possible to proceed, as for the obtaining of a colour variation, by partitioning the mould so as to avoid the mixing of compositions that are intended to form the regions of the device having different hardness characteristics. It is also possible to successively mould each of the parts and to wait for one part to set before moulding the next.

It is also possible to mould the support layer with a variable thickness that will modify the way in which the multilayer complex behaves locally, for example a thickness variation of from 5 μm to 5 cm.

In order to obtain a variable thickness, the mould is, for example, inclined such that the thickness of the composition intended to form the support layer varies continuously from the lower edge to the upper edge. In this case, the formulation of the support layer may be homogeneous for the entire device.

A thickness variation can of course be combined with a formulation variation.

It is also possible to include, in the support layer, elements which are softer or harder than the support layer in order to simulate spots, skin indurations, or a bone or cartilage effect.

The variation in the Shore hardness of the support layer ranges, for example, from 00-35 to 00-5.

The device 1 according to the invention may exhibit, as illustrated in FIG. 7, a variation in a characteristic, for example the hardness, in one direction A and a variation in another characteristic, for example colour or surface condition, in a second direction B perpendicular to the first.

Represented in FIG. 10 is an atlas for evaluating, in vivo, the firmness and the surface condition, comprising several application supports 10_{i,j} each produced with a multilayer complex according to the invention, while varying the surface condition and the hardness, the supports 10_{i,j} having, for example, on the same line i, different surface conditions but the same hardness, and from one line i to another i+1 different hardnesses, the same surface condition being located on a column j. The various supports are, for example, attached to a plate.

Represented in FIG. 3 is a contrast card, produced in accordance with the invention, comprising a white region 10₁ and a black region 10₂.

FIG. 4 represents a device in which the various regions 10₁ and 10ₙ are arranged according to sectors around a central region 20, which has for example a circular outline and exhibits two half-regions 20a and 20b which are respectively black and white. This gives, for example, the surface condition which varies while progression is made along the circumference around the central region 20, going for example from very smooth skin to skin which is increasingly rough or wrinkled.

Represented in FIG. 5 is an example of a device comprising several contiguous regions exhibiting a colour variation from one region to another, from the lightest to the darkest.

Represented in FIG. 6 is an example of a device comprising contiguous regions of different hardnesses.

In the Examples of FIGS. 5 and 6 in particular, the device is produced with the same skin layer for the various regions, such that, when the product is applied, the finger or the applicator slides over the application surface from one region to another without the user being able to detect the crossing of the junction.

Represented in FIG. 8 is an epithesis 100 implementing an aspect of the invention, namely the use of a multilayer complex according to the invention, as described for example with reference to FIG. 2, comprising a skin layer 4 and a support layer 5. The skin layer 4 reproduces the skin relief.

The epithesis 100 can be produced in a personalised manner, from an impression of the skin relief taken on a region of the body or of the face adjacent to that on which the epithesis must be placed.

It is also possible, where appropriate, to take a colourimetric measurement and to perform mass-tinting of the support layer in a corresponding manner. It is also possible to print the skin layer on its internal face in such a way as to adjust the colour as closely as possible to that of the skin around the epithesis. It is possible, for example, to reproduce, on the skin layer, an image of the skin around the epithesis in order to make the boundary between the epithesis and the surrounding skin as unnoticeable as possible.

The pattern printed on the internal face of the skin layer is repeatable from one epithesis to another.

The epithesis can be aimed at transforming or modelling the face or any region of the body. The epithesis can be used to fill wrinkles. The underneath of the epithesis can have a relief complimentary to the area on which it will be placed. When the epithesis is not made to measure, a range of epitheses corresponding to various shapes, colours, colour microheterogeneities, to various reliefs and/or hardnesses, in accordance with the neighbouring skin, can be produced.

One advantage of an epithesis according to the invention is that makeup can be applied thereto, thereby making it more difficult to see.

The epithesis may be disposable or may be reusable.

Represented in FIG. 12 is a variant of an epithesis 100. The latter can have, as illustrated, a thinned edge 110, of reduced thickness. In order to produce the thinned edge 110, the skin layers 4 and 7 can join together on a peripheral band 115, the thickness of the support layer 5 then being zero. The width w of the band 115 ranges, for example, from 1 to 4 mm.

In the example of FIGS. 12 and 13, the internal face 120 of the epithesis is planar.

In the variant shown in FIG. 14, the internal face 120 has a projecting profile suitable for filling a recessed area of the skin, for example a wrinkle. In this case, the thickness of the support layer 5 varies.

Generally, the epithesis can have, on its internal face, a relief which corresponds to the negative of the surface on which the epithesis is placed.

In some variants not shown, the skin layers 7 of the examples of FIGS. 13 and 14 are absent.

Represented in FIG. 9 is an atlas for evaluating the firmness of the skin, with various grades of softness. Each region of the atlas is, for example, defined by a support produced with a multilayer structure according to the invention, and preferably comprises a support layer made of silicone elastomer included between two external skin layers. Each support is, for example, in the shape of a disc. The mould used to produce each support comprises an impression corresponding to that left on the skin by the application of an end piece with a predefined force for a controlled duration. The end piece belongs, for example, to an apparatus as described in publication FR 2 840 795 which applies a controlled pressure of 2 kg on the skin.

Depending on the firmness of the skin, the latter marks more or less deeply under the effect of the apparatus, and moulding of the relief of the impression left on the skin by the apparatus is carried out, said impression being produced as a negative on the mould, and then as a positive on the multilayer complex.

For a given support, the formulation of the support layer is chosen so as to reproduce as closely as possible the firmness of the skin of which the mark left by the apparatus was reproduced on this support. Such an atlas can be used for evaluating, in vivo, the firmness of the skin. The operator can not only evaluate the firmness in a tactile manner, but can also do so visually by comparing the appearance of the mark left on the skin by the apparatus with the appearance of the mark on the various supports of the atlas.

The invention is not limited to the examples which have just been described, the characteristics of which may be combined with one another.

The expression “comprising a” is synonymous with “comprising at least one”.

1. Device for evaluating a product on application, comprising an application surface defined by a multilayer complex which has at least two application regions which differ in terms of their surface condition and/or their hardness, the multilayer complex comprising a skin layer and an underlying support layer made of elastomer, the device being arranged to allow the application of the product to said regions in a single action.

2. Device for evaluating a skin typology or a product on application, comprising an external surface defined by a multilayer complex which has at least two regions which differ in terms of their colour, their surface condition and/or their hardness, the multilayer complex comprising a skin layer and an underlying support layer made of elastomer, the skin layer reproducing the skin relief.

3. Device for evaluating a skin typology or a product on application, comprising an external surface defined by a multilayer complex, the multilayer complex comprising a skin layer made of polyurethane elastomer and an underlying support layer made of silicone elastomer.

4. Device according to claim 3, the external surface having at least two regions which differ in terms of their colour, their surface condition and/or their hardness.

5. Device for evaluating a product on application, comprising an application surface defined by a multilayer structure which has a skin layer and a support layer made of elastomer, and, between the two, at least one intermediate element which makes it possible to carry out a detection or a physicochemical measurement, in particular a functional layer comprising a compound capable of reacting with one or more predefined target molecules having migrated through the skin layer.

6. Device according to claim 5, the application surface having at least two regions which differ in terms of their colour, their surface condition and/or their hardness, and/or at least two regions which have different respective functional layers.

7. Device according to claim 1, the two regions reproducing a skin microrelief, the skin layer being moulded with said microrelief.

8. Device according to claim 1, the two regions being pinpointed by identifiers.

9. Device according to claim 1, the two regions differing only in terms of hardness, colour or surface condition.

10. Device according to claim 1, the skin layer being made of elastomer.

11. Device according to claim 1, the support layer being made of silicone elastomer.

12. Device according claim 1, one of the surface-condition, colour or hardness characteristics varying in a first direction, while another of said characteristics varies in another direction.

13. Device according to claim 1, comprising at least three regions one characteristic of which, chosen from the surface condition, the colour or the hardness, exhibits different respective grades.

14. Device according to claim 1, comprising white and black regions.

15. Device according to claim 1, the various regions being arranged around a central zone of a disc.

16. Device according to claim 1, the various regions being in the form of juxtaposed parallel strips.

17. Device according to claim 1, comprising printing between the skin layer and the support layer.

18. Device according to claim 1, reproducing a mark left on the skin by an end piece applied to the skin with a predefined force, for a controlled duration.

19. Method for evaluating on application a cosmetic product, comprising:
applying the product to a device according claim 1, so as to at least partially cover the two regions.

20. Contrast card comprising a multilayer complex defining two application regions of different colours, respectively white and black, the multilayer complex comprising a skin layer and a support layer made of elastomer, the skin layer being microstructured, reproducing the skin relief, the skin layer being made of polyurethane elastomer, and the support layer being made from a reactive silicone mixed with a silicone oil.

21. Method for manufacturing a multilayer complex, the application surface of which is produced with patterns or signs which are visible, the application surface being intended for the application of cosmetic or dermatological products, reproducing a skin microrelief, the application surface reproducing colour heterogeneities and/or identifiers, the method comprising:
applying in a mould a composition intended to form a skin layer of the multilayer complex,
printing on an internal face of this skin layer, in particular so as to form said colour heterogeneities and/or the identifiers, then
pouring into the mould, on the skin layer, a composition intended to form a support layer of the multilayer structure, the pattern(s) imprinted on the skin layer being visible on the application surface by virtue of the transparency of the non-opaque skin layer.

22. Epithesis or device, for evaluating a cosmetic or dermatological product on application, comprising:
a skin layer made of elastomer, which is microstructured, which reproduces the skin microrelief, the skin layer defining, with its external surface, the application surface and being printed on its internal face,
a support layer made of silicone elastomer, adjacent to the skin layer, moulded in contact therewith.

23. Atlas for evaluating the firmness of the skin, comprising various regions reproducing the appearance of a mark made on the skin by applying an end piece to said skin with a predefined force, the various regions being produced with a multilayer complex comprising a skin layer and a support layer, the skin layer being made of elastomer, the support layer being made of elastomer.
